(19) United States
(12) Patent Application Publication
(10) Pub. No.: US 2015/0154577 A1
(43) Pub. Date: Jun. 4, 2015

(54) Communication Control and Compensation

(71) Applicant: Educon Management Consultancy, Dubai (AE)

(72) Inventor: Abdul JABBAR Abdulla Ali Gargash, Dubai (AE)

(73) Assignee: Educon Management Consultancy, Dubai (AE)

(21) Appl. No.: 14/096,198

(22) Filed: Dec. 4, 2013

(51) Int. Cl. G06Q 20/14; G06Q 20/16

(52) U.S. Cl. CPC G06Q 20/14; G06Q 20/16

(57) ABSTRACT

Novel tools and techniques to allow users more control over communications directed to that user. In one aspect, for example, these tools can provide a user with compensation for agreeing to receive communications, and in particular (but not limited to) unsolicited communications, and the tools can accommodate a wide variety of different modes of communication, including without limitation voice communications, electronic medications, and/or the like. In some cases, a system can provide a tool to consolidate management of such communications, such as an application that executes on the user device and/or can communicate with a communication server. The communication server, and some aspects, can receive incoming communications for the user and control access to the user according to the user's preferences.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to the field person-to-person communications and more particularly, to tools and techniques for enabling a communication recipient to be compensated for receiving communications.

### BACKGROUND

In the past, telemarketing calls have been an important part of many marketing campaigns. While the effectiveness of such strategies can be assumed from their prevalence, the fact remains that such calls tend to annoy many of their recipients. With the advent of additional modes of communication, such as electronic mail (“email”), text messages, and social networking, marketing communications have assumed an ever-increasing role in the daily lives of most people. In fact, some studies have indicated that “spam” messages have comprised between 65-90% of global email traffic in the recent past.

There have been many attempts, both regulatory and technical, to deal with the issue of unwanted communications. For example, regulatory solutions like “no call lists” attempt to prevent unwanted telephone communications, and many electronic mail servers, clients, and third-party solutions attempt to identify and filter spam messages from other email traffic.

Such solutions, however, suffer from several shortcomings. First, no single solution is universal for a particular user. The user might have to subscribe to multiple no call lists, spam filtering services, and/or the like. Second, such solutions are, almost by definition, both over-inclusive and under-inclusive when determining how to filter traffic. For example, despite the presence of national no call lists, many people still receive unwanted telemarketing calls, from entities who are exempt from such regulations and/or choose to ignore them. At the same time, a person might be open to receiving a certain type of marketing call (e.g. a call that appeals to that person's particular interests) but may not ever receive such a call, because that person has registered with a no call list. Similarly, with electronic mail, many spam messages managed to evade even the best spam filters, while legitimate messages often can be trapped and/or discarded inadvertently by such filters.

Further, in some cases, a user might be willing to receive unsolicited communications, but might wish to be compensated for the impact on his or her time. Similarly, some entities might be willing to pay users for their communications (e.g. as just another aspect of an advertising expense budget). Universal solutions such as no call lists and spam filters failed to provide the sort of fine-grained controls that could allow such an arrangement.

Hence, there is a need for more robust solutions to the problem of unsolicited communications.

### BRIEF SUMMARY

A set of embodiments provides tools and techniques to allow users more control over communications directed to that user. In one aspect, for example, some embodiments can provide a user with compensation for agreeing to receive communications, and in particular (but not limited to) unsolicited communications. Various embodiments can accommodate a wide variety of different modes of communication, including without limitation voice communications, electronic medications, and/or the like. In certain embodiments, the system can provide a tool to consolidate management of such communications, such as an application that executes on the user device and/or can communicate with a communication server. The communication server, and some aspects, can receive incoming communications for the user and control access to the user according to the user's preferences.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible and/or non-transitory computer readable media (such as, to name but a few examples, optical media, magnetic media, and/or the like).

One set of embodiments, for example, provides systems for managing communications. An exemplary system might comprise a communication server, which might be in communication with a client application on a user device. In some embodiments, the communication server comprises one or more processors and one or more non-transitory computer readable media, which can have encoded thereon a set of instructions executable by the processor(s) to cause the communication server to perform one or more operations, including without limitation one or more operations provided by methods in accordance with various embodiments.

Merely by way of example, the set of instructions might comprise instructions to store (e.g., at the communication server or the client device) communication preferences for a user of the client application on the user device. In some aspects, the communication preferences might comprise, without limitation, a preference regarding communication fees applicable to one or more third parties. The set of instructions might further comprise instructions to receive a communication from a third party and/or instructions to determine a fee for completing the communication. In some cases, the system might determine the fee based on the communication preferences. In particular embodiments, the set of instructions can also include instructions to determine that the third party is willing to pay the fee. The set in instructions, then, can include instructions to perform a financial transaction to charge the fee to the third party. Based on payment of the fee by the third party, the instructions can also include instructions to complete the communication to the client application.

An apparatus in accordance with another set of embodiments might comprise a non-transitory computer readable medium having encoded thereon a set of instructions executable by one or more computers to perform one or more operations, including without limitation operations provided by methods in accordance with various embodiments. Merely by way of example, the set of instructions might comprise instructions similar to those with which the communication server above is programmed.

Another set of embodiments provides user devices. An exemplary user device might comprise a processor and a non-transitory computer readable medium having stored thereon a client application for a communication server. In an aspect, the client application might comprise a set of instructions executable by the processor. Merely by way of example, the instructions might comprise instructions to receive user input specifying one or more communication preferences regarding communication fees applicable to one or more third parties. The client application might include further instructions to communicate the one or more communication preferences to the communication server and/or instructions to receive a communication from a third party, via the communication server, after the third party has agreed to pay a communication fee applicable to that third party.

Yet another set of embodiments provides methods. An exemplary method might comprise storing, e.g., on a communication server computer, communication preferences for a user of a client application on a user device, the communication preferences comprising a preference regarding communication fees applicable to one or more third parties. The method can further include, in some embodiments, receiving, by the communication server computer, a communication from a third party. In another aspect, the method might comprise determining, by the communication server computer, a fee for completing the communication, based on the communication preferences and/or determining, by the communication server computer, that the third party is willing to pay the fee. If so, the method might feature performing, by the communication server computer, a financial transaction to charge the fee to the third party, and/or completing, with the communication server computer, the communication to the client application, based on payment of the fee by the third party.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram illustrating a communication server, in accordance with various embodiments.

FIG. 2 is a block diagram illustrating a system for controlling and compensating for communications, in accordance with various embodiments.

FIG. 3 is a process flow diagram illustrating a method of controlling and compensating for communications, in accordance with various embodiments.

FIG. 4 is a generalized schematic diagram illustrating a computer system, in accordance with various embodiments.

FIG. 5 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

A set of embodiments provides tools and techniques to allow user more control over communications directed to that user. In one aspect, some embodiments can provide a user with compensation for agreeing to receive communications, and in particular (but not limited to) unsolicited communications. So, for example, if a caller wants to speak on the telephone with a subscriber of the system provided by some embodiments, that caller can be informed that he or she must pay a fee before the call will be completed to the subscriber. In various aspects, this fee can vary according to the nature of the caller (private individual, business, etc.) and/or based on the subscriber's preferences (e.g., family and personal friends pay nothing, others pay an amount—or different amounts—to have the call completed). In this way, certain embodiments can reimburse a subscriber for the time taken to receive and/or respond to communications from others, especially unsolicited communications.

Various embodiments can accommodate a wide variety of different modes of communication, including without limitation voice communications, electronic medications, and/or the like. For example, a communication server might provide intermediary services for voice calls (e.g., by serving as a voice switch, electronic mail (e.g., by serving as a mail server), text messages, and the like. Subscribers can configure user preferences to assign fees for such communications in many different ways. For example, voice communications might entail a higher fee generally, because they require real-time interaction by the subscriber, while electronic mail and text messages can be passively received by the subscriber. Further, the system might charge one fee to deliver an electronic mail or text message, and an additional (or higher) fee to guarantee a response from the subscriber to the sender of the message.

Further, subscribers can establish different classes of entities with whom they will communicate, and different fee structures can apply to each class; for example, as noted above, a subscriber might receive communications from personal acquaintances for free, might receive communications from unknown individuals for another fee, and might receive marking communications for yet another fee. In various aspects, the system might have the ability to discriminate between these classes of entities in a variety of different ways. Personal acquaintances might be identified based on the subscriber's own address book or contact list; marketing communications might be identified based on the content of a message, identifying information about the sender (telephone number, domain name, etc.), or other information; all other entities might be identified by default as unknown individuals.

Moreover, in some cases, the system can provide for ad hoc determinations of the fee amount and/or can allow a subscriber to set fee policies but then modify those policies in real time. For example, the system might notify the subscriber of a communication, and the subscriber might reply to that notification with an indication of the fee to be charged for completing that particular communication. In this way, different embodiment can provide both ease-of-use for the subscriber (who can setup communication preferences and then let the system handle communications automatically) with a high degree of flexibility on a per-communication basis, as desired by the subscriber. In some cases, for instance, the subscriber might have fees set for all known marketing communications but might want to be notified of communications from unknown individuals, so that the subscriber can decide whether to charge a fee (and how much fee to charge) on a per-communication basis for entities considered by the system to be unknown individuals.

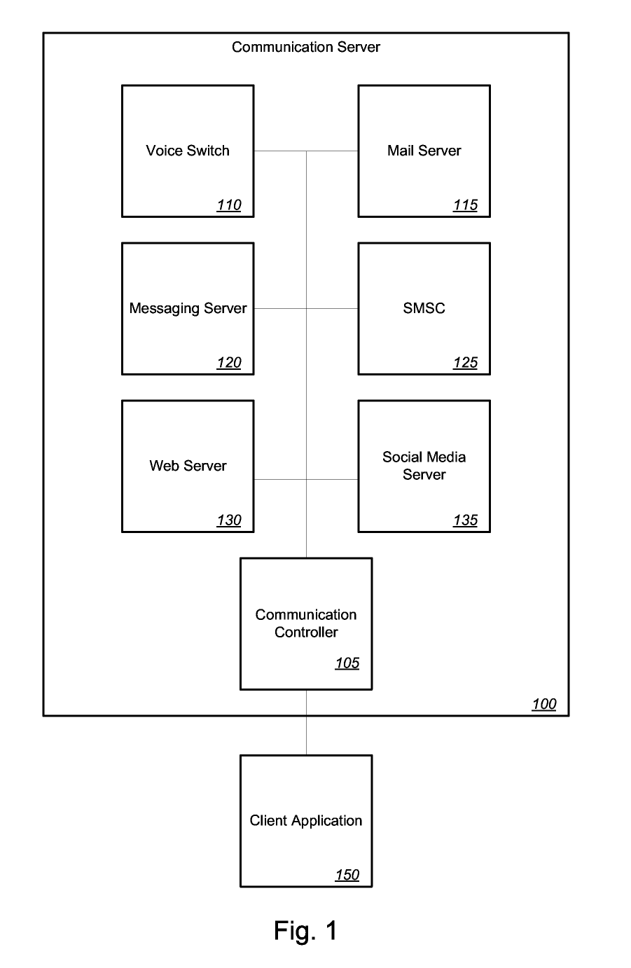

Turning to the figures, for example, FIG. 1 is a functional diagram illustrating a communication server 100, in accordance with various embodiments. While illustrated functionally on FIG. 1, the communication server 100 can comprise a variety of different hardware platforms, can be embodied by one or more virtual machines, and/or the like. Hence, the reader should appreciate that the hardware implementation and architectural arrangement of the communication server 100 can vary among different embodiments, and that FIG. 1 is intended to illustrate functional relationships of various components within a typical communication server 100. Hence, the various functions provided by the communication server 100 can be distributed among different servers or platforms in some embodiments, or can be provided in a single, unified server in other embodiments.

In an aspect, the communication server 100 might be operated by a communication provider, which provides communication services to subscribers, usually (but not necessarily) for a fee. Hence, the communication control techniques described herein can be offered as a service by the communication provider, for example as part of a basic voice calling service, email service, and/or the like. Alternatively, the techniques described herein may be provided as an enhanced service by a communication provider that provides other services as well. In further embodiments, the communication control services described herein may be provided by a third-party communication provider, which does not provide other voice calling or data services, and the techniques described herein may be performed on communications handled by other providers within the subscriber has relationships; for instance, the subscriber might simply route communications handled by those providers through the communications server 100 (e.g., using call forwarding, electronic mail redirection or forwarding, and/or the like).

In general, the communication server 100 comprises a communication controller 105 and one or more other server components (e.g., servers 110-135) that can handle various types of communications incoming to and/or outgoing from subscribers to the service. The communication controller 105 can serve as an interface to a client application 150 (e.g., to receive user preference information and to otherwise provide a user interface between the communication server 100 and the subscriber) and functions to control incoming communications intended for a subscriber of the service, and/or to allow those communications to be completed to the subscriber only when the communications comply with policies set by the subscribers' communication preferences (e.g., when the communicating party agrees to pay a fee for the subscriber to receive the communication). Hence, when a server component receives a communication for a subscriber, rather than immediately completing the communication to the subscriber, the server component will communicate with the communication controller 105 to determine how that communication should be handled, based on preferences stored in the communication controller 105. For example, upon receiving a communication, the server component might notify the communication controller 105 of the communication; the communication controller 105 might inspect the communication, identify the third party attempting to communicate with the subscriber, determine how the communication should be handled, and instruct the server component to handle the communication accordingly. In practice, communications that are allowed to be completed might pass through the communication controller 105, and/or the various server components 110-135 might communicate directly with subscriber devices to complete the communication. Similarly, the control functions described herein might be implemented by a general communication controller 105 and/or by various functions within the server components 110-135 themselves. Hence, the arrangement of FIG. 1 is intended to be an example of only one of many possible embodiments and should not be considered limiting.

In an aspect, the communication controller 105 (or other component of the server 100) might comprises a user interface. The user interface can allow users (including without limitation subscribers and third parties attempting to communicate with subscribers) to interact with the communication server 100. A variety of user interfaces may be provided in accordance with various embodiments. For example, the system might provide a voice interface (such as an interactive voice response (“IVR”) unit) for interacting with subscribers by voice command and/or for interacting with third parties (for example, to receive payment information from the third party). Any of the server components can also provide a user interface—for example, upon receiving an email message from a third party, the communication server 100 might transmit a reply email requesting payment information and might receive another reply, in turn, with the payment information.

In some cases, however, the communication controller 105 (or other component) might offer a more comprehensive user interface to allow a subscriber to interact with the system (for instance, to set communication preferences). Merely by way of example, in some embodiments, the system may be configured to communicate with a user computer (such as a subscriber device) via a dedicated client application 150 running on the user computer; in this situation, the user interface might be displayed by the client application, based on data and/or instructions provided by the communication server. In this situation, providing the user interface might comprise providing instructions and/or data to cause the client computer to display the user interface. In other embodiments, the user interface may be provided from a web server, e.g., by providing a set of one or more web pages, which might be displayed in a web browser running on the user computer and/or might be served by a web server (described below). In various embodiments, the communication server might comprise the web server and/or be in communication with the web server, such that the communication server provides data to the web server to be incorporated in web pages served by the web server for reception and/or display by a browser at the user computer.

The communication server 100 can include a wide variety of server components, and those components can be arranged and/or combined in different ways in accordance with various embodiments. In some cases, the communication server 100 might feature only one server component (i.e., function as a specialized server for one type of communication), while in other cases, the communication server 100 might feature multiple server components. Likewise, as indicated above, while FIG. 1 illustrates a monolithic communication server 100, communication servers might feature a number of different server components, each running on separate hardware. In one aspect, the communication server 100 might run in a cloud environment, and each of the server components might run in separate (or the same) containers or virtual machines. Further, it should be appreciated that the communication server 100 is scalable and might have multiple nodes of each type of communication component.

As one example of a server component, the communication server 100 might include a voice switch 110. The voice switch 110 can be any of a variety of switches or servers that support voice communications. Examples include a VoIP soft switch, which might be configured to interface with subscriber clients and other IP switches using session initiation protocol (“SIP”) or other suitable protocols, and to interface with the public switched telephone network (“PSTN”) using conventional time division multiplexing (“TDM”) signaling. In other embodiments, the voice switch 110 might be a PSTN switch, for example, if the communication provider is a local exchange carrier; and/or a wireless switch, for example, if the communication provider is a wireless carrier. In any case, the voice switch 110 is configured to receive voice communications (whether VoIP, TDM, wireless, and/or the like) intended for subscribers of the communication provider and/or to originate calls on behalf of subscribers. In an aspect, the voice switch 110 can operate much like a conventional voice switch, except that the switch 110 might be modified to control incoming communications to the subscriber as described further herein. In some cases, a telephone number for the subscriber might be ported to the voice switch 110, such that all calls to the telephone number are routed to the voice switch 110 via the PSTN (or other networks) in conventional fashion. In other cases, the subscriber may be provided with a forwarding number associated with the voice switch 110, so that the subscriber can forward calls from other subscriber numbers to the forwarding number.

In some embodiments, the communication server 100 can include a mail server 115, such as a Simple Mail Transfer Protocol (“SMTP”) server, which can also act as a mail transfer agent (“MTA”). The mail server 115 can act as a conventional mail server/MTA, in that it can communicate with other mail servers and mail clients (e.g., on subscriber devices), except that it can be configured to control the deliver of mail (especially the delivery of incoming mail addressed to a subscriber) in accordance with the communication control techniques described herein.

In further embodiments, the communication server 100 can comprise a messaging server 120 and/or a short message service (“SMS”) center (“SMSC”) 125, either of which can be used to receive messages for a user. The messaging server 120 might operate to receive text or multimedia (e.g., audio and/or video) messaging and/or chat sessions for subscribers on a variety of messaging services or networks, such as Apple Messages™, AOL Instant Messenger™, Skype™, and/or the like. The SMSC can function as a destination for SMS messages and can relay such messages (if permissible) to the subscriber. If the communication server 100 does not include an SMSC, the messaging server 120 might be configured to implement the Mobile Application Part (“MAP”) of the Signaling System 7 (“SS7”) protocol and/or SIGTRAN signaling transport interfaces for communicating with an SMSC in the PSTN; as such the messaging server 120 could function as an intermediary for SMS messages in the same way as other messaging traffic. As with the other server components, the messaging server 120 and the SMSC 125 can be configured to control the delivery of such messages in accordance with policies set by communication preferences.

In some cases, the communication server 100 can include a web server 130, which can be used to provide control over web communications and/or to provide a user interface for a subscriber to the service (e.g., as an interface for the communication controller 105).

In a particular set of embodiments, the communication server 100 can include a social media server 135, which can serve as an intermediary between a subscriber and a variety of social media services, such as Facebook™, Twitter™, LinkedIn™ and/or the like. If a third party attempts to communicate with a subscriber's account on one of these services, the social media server 135 can interact with the service on the subscriber's behalf to interact with the third party and perform communication control functions as described herein.

In certain embodiments, the system can provide a tool to consolidate management of a variety of different types of communications; one such tool is the client application 150, which can execute on one or more subscriber devices and/or can communicate with a communication server. In some cases, the client application might be integrated with an operating system of the subscriber device. In other cases, the client application might be an installable executable available at an App Store or the like. In either case, the client application can provide functionality for communicating through the communication server. For example, the client application might include a Voice over Internet Protocol (“VoIP”) client for receiving voice calls, an electronic mail client for receiving electronic mail, a text message and/or SMS client for receiving text messages, one or more social media clients, and/or the like. In some cases, the functionality of these clients might be divided among different applications and/or handled by native applications on the subscriber device, in which case the client application might be responsible merely for handling interaction with the communication server to configure communication preferences, receive and respond to notifications, etc., while other applications handle the communications that are completed to the subscriber device by the communication server. In other cases, the client application might handle all aspects of the communication, including receiving communications from the communication server, originating communications to others through the communication server, and/or the like.

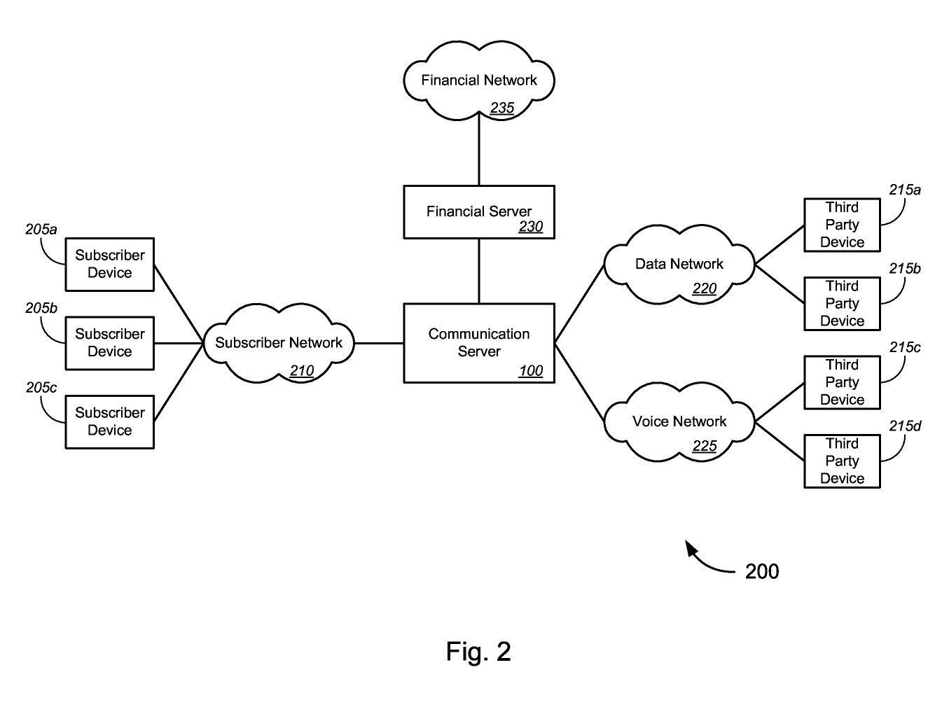

FIG. 2 is a block diagram illustrating a system 200 for controlling and compensating for communications, in accordance with various embodiments. The system 200 includes a communication server 100, such as the server described above, which can be in communication with a plurality of subscriber devices 205. As noted above, in an aspect, the communication server 100 can be operated by a communication provider as a service for subscribers of the communication provider (each of which has one or more subscriber devices 205 to which communications can be completed as described below).

While FIG. 2 depicts three subscriber devices for purposes of illustration, the skilled reader should understand that many embodiments will include a much larger of subscribers, and that a single subscriber might have multiple devices 205 that interact with the communication server 100 as described herein. A subscriber device 205 can be any device that is capable of receiving a communication from the communication server 100 and can include, without limitation, wireless phones (including smart phones, feature phones, etc.), wired phones (e.g., plain old telephone system (“POTS”) phones, VoIP phones, etc.), tablet computers, handheld computers, personal computers, communication-enabled watches, and/or any other type of device with communication capabilities. Hence, a typical subscriber might have a number of devices 205 in communication with the communication server 100: a personal computer, a wireline home phone, a wireless phone, and a tablet computer. The subscriber might establish, in the subscriber's user preferences, which types of communications should be routed to which devices, and in what order (for example, if the subscriber desires features like simultaneous ring or sequential ring). Different subscriber devices 205 can be identified to the communication server in a number of different ways, such as SIP registrations, MAC addresses, IP addresses, wireless registrations, and/or the like, so that the communication server 100 can communicate with the appropriate device 205 in each situation.

The communication server 100 can communicate with the subscriber devices 205 over a subscriber network 210. The subscriber network 210, which can be any of a variety of types of networks (including those described below), or various combinations thereof, can provide communication between the communication server 100 and the subscriber devices. In a particular aspect, the subscriber network 210 can be embodied by the Internet, or more specifically, by virtual private networks (“VPN”) between the communication server 100 and each subscriber device 205 (or, in some cases, by a VPN between the communication server 100 and another private network that hosts one or more of the subscriber devices 205). Any appropriate VPN technology, such as Internet Protocol Security (“IPsec”), secure sockets layer (“SSL”), and/or the like, can be used to establish the VPNs. In one aspect, a client application on the subscriber device 205 can establish a VPN with the communication server 100 (either automatically or based on user input), and the client and server 100 can communicate over the VPN tunnel using IP communications. (In some embodiment, any communications between the client application and the server 100 described herein can be conducted in this manner.)

The system 200, and more particularly in the illustrated embodiment, the communication server 100, can receive communications from a plurality of third parties (e.g., using third party devices 215) directed toward one or more users of the system and can manage those communications as described in further detail below. More specifically, the communication server can complete a communication from a third party device 215 to one or more of the subscriber devices 205 if the communication server 100 determines that the communication should be completed.

A number of third party devices 215 are possible, and the nature of the device depends on the type of communication. In general, however, any device that could function as a subscriber device 205 could also function as a third party device 215, the difference being that subscriber devices 205 are operated by or associated with subscribers to the system, while third party devices are operated by third parties attempting to communicate with a subscriber. (Of course, if one subscriber attempts to communicate with another subscriber, the subscriber device 205 could function as a third party device 215 for that particular communication.) The communication server 100 might receive such communications from third parties over a data network 220, such as the Internet and/or a providers core network, access network, etc.; and/or a voice network 225, such as the PSTN, depending on the embodiment and the nature of the incoming communication. Once again, any suitable network, and in particular the Internet, can serve as the data network 220 and/or the voice network.

In some embodiments, the communication server 100 might be in communication with (and/or might comprise) a financial server 230, which is configured to process financial transactions, as described in detail below. In particular, the financial server 230 might provide communication with a financial network 235, such as an automated clearinghouse (“ACH”), an example of which is operated by NACHA—The Electronic Payments Association™; a credit card network; and/or the like. Generally speaking, the financial server 230 can process payments to debit a third party account (such as a credit card account or a checking account, to name a couple of examples) and/or credit a subscriber account (such as an account with the communication provider, an outside account with a financial institution, and/or the like).

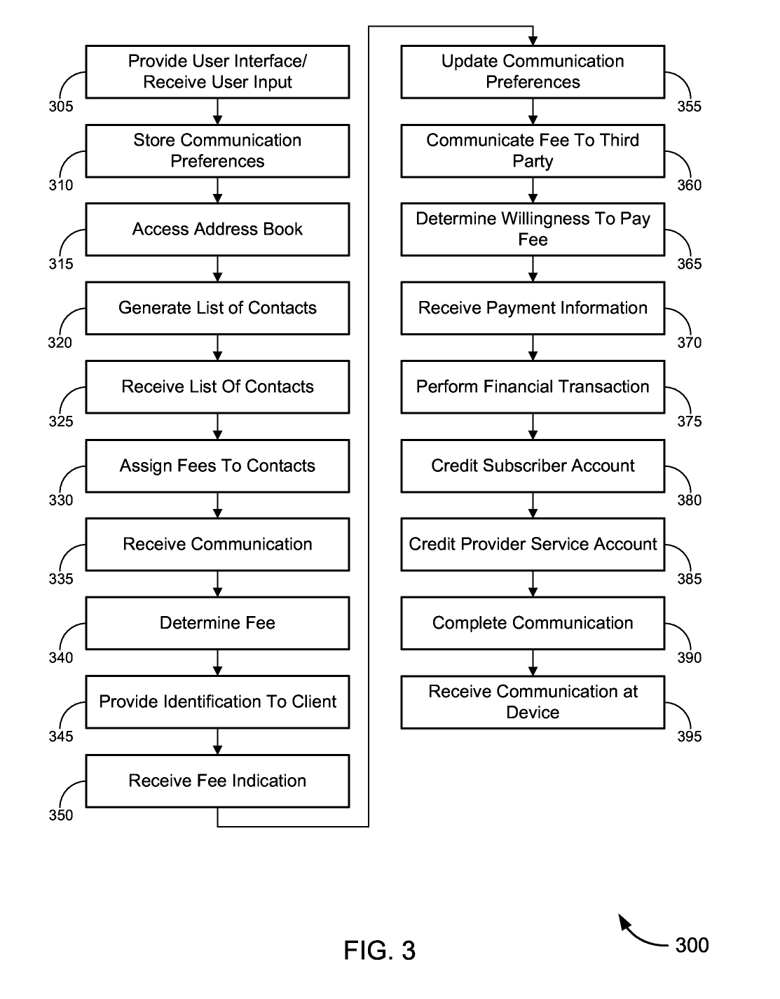

While the detailed operation of a system such as the system 200 is described below with regard to FIG. 3, the communication server 100, in general, can receive an incoming communication from a third party device 215 over a network 220 or 225. The incoming communication will be intended for one of the subscribers to the communication provider that operates the communication server 100, and the communication server 100 will determine whether a fee should be paid to the subscriber for receiving the communication. If so, the communication server 100 will obtain payment information from the third party and will process a financial transaction, using the financial server 230 and the financial network 235. Upon successful completion of the transaction, the communication server 100 will complete the communication to an appropriate subscriber device 205 (which, as noted above, might be executing a client application that can receive the communication) over the subscriber network 210.

An example of a more detailed implementation of such techniques is provided by FIG. 3, which is a process flow diagram illustrating a method 300 of controlling and compensating for communications, in accordance with various embodiments. While the method 300 of FIG. 3 is illustrated, for ease of description, as a single method, it should be appreciated that the various techniques and procedures of the method 300 can be combined in any suitable fashion, and that, while the techniques and procedures are depicted and/or described in a certain order for purposes of illustration, it should be appreciated that certain procedures may be reordered and/or omitted within the scope of various embodiments. Moreover, while the method illustrated by FIG. 3 can be implemented by (and, in some cases, is described below with respect to) the system 200 of FIG. 2 and/or the communication server 100 of FIG. 1 (or components thereof), these methods may also be implemented using any suitable hardware implementation. Similarly, while the system 200 of FIG. 2 and the communication server 100 of FIG. 1 (and/or components thereof) can operate according to the method illustrated by FIG. 3 (e.g., by executing instructions embodied on a computer readable medium), the communication server 100 and/or system 200 can also operate according to other modes of operation and/or perform other suitable procedures.

The method 300, in the illustrated embodiment, comprises providing a user interface to allow interaction between a user (e.g., a subscriber, a third party, etc.) and the system (or more particularly, the communication server) and receiving user input through that user interface (block 305). For example, the user interface can be used to output information for a user, e.g., by displaying the information on a display device, printing information with a printer, playing audio through a speaker, etc.; the user interface can also function to receive input from a user, e.g., using standard input devices such as mice and other pointing devices, motion capture devices, touchpads and/or touchscreens, keyboards (e.g., numeric and/or alphabetic), microphones, etc.

The procedures undertaken to provide a user interface, therefore, can vary depending on the nature of the implementation; in some cases, providing a user interface can comprise displaying the user interface on a display device; in other cases, however, in which the user interface is displayed on a device (e.g., subscriber device) remote from the computer system (such as on a user computer, wireless device, etc.), providing the user interface might comprise formatting data for transmission to such a device and/or transmitting, receiving and/or interpreting data that is used to create the user interface on the remote device. Alternatively and/or additionally, the user interface on a user computer (or any other appropriate user device) might be a web interface, in which the user interface is provided through one or more web pages that are served from a computer system (and/or a web server in communication with the computer system), and are received and displayed by a web browser on the client computer (or other capable user device). The web pages can display output from the computer system and receive input from the user (e.g., by using Web-based forms, via hyperlinks, electronic buttons, etc.). A variety of techniques can be used to create these Web pages and/or display/receive information, such as JavaScript, Java applications or applets, dynamic HTML and/or AJAX technologies, to name but a few examples.

In some cases, as noted above, the user interface might include a voice interfaces (such as an IVR) and/or an interface through the mode of communication employed by a third party (e.g., mail, text message, etc.). In other cases, providing a user interface will comprise providing one or more display screens each of which includes one or more user interface elements. As used herein, the term “user interface element” (also described as a “user interface mechanism” or a “user interface device”) means any text, image, or device that can be displayed on a display screen for providing information to a user and/or for receiving user input. Some such elements are commonly referred to as “widgets,” and can include, without limitation, text, text boxes, text fields, tables and/or grids, menus, toolbars, charts, hyperlinks, buttons, lists, combo boxes, checkboxes, radio buttons, and/or the like. While any illustrated exemplary display screens might employ specific user interface elements appropriate for the type of information to be conveyed/received by computer system in accordance with the described embodiments, it should be appreciated that the choice of user interface elements for a particular purpose is typically implementation-dependent and/or discretionary. Hence, the illustrated user interface elements employed by any display screens described herein should be considered exemplary in nature, and the reader should appreciate that other user interface elements could be substituted within the scope of various embodiments.

As noted above, in an aspect of certain embodiments, the user interface provides interaction between a user and a computer system. Hence, when this document describes procedures for displaying (or otherwise providing) information to a user, or to receiving input from a user, the user interface may be the vehicle for the exchange of such input/output. Merely by way of example, in a set of embodiments, the user interface allows a third party to interact with the system to agree to payment terms, provide payment information, and/or the like. Perhaps more importantly, however, the user interface can also allow a subscriber to provide user input regarding that subscriber's communication.

A subscriber can have a wide variety of user preferences in accordance with different embodiments. Most pertinently, a subscriber can have communication preferences that specify amounts of communication fees that should be charged to third parties to allow those third parties to communicate with the subscriber. As noted above, the communication preferences can provide relatively broad or relatively fine-grained control over fees to be charged to third parties, based on the subscriber desires and/or system implementation. So, for example, communication preferences might specify different fees for different types of communications (electronic mail, voice, text, and or the like) different third parties (or types of third parties, such as known associates, unknown individuals, advertisers, etc.) different fees for different times of day, days of week, etc., and/or the like. In some cases, communication preferences might specify that the subscriber should be consulted in real-time with regard to some or all of the fees that should be charged. For example, the communication preferences might specify that, for a particular group of family and friends, no fee should be charged for any type of communication at any time, for other individuals in the subscriber's contact list, a particular fee schedule should be applied, and that for all other people not in the subscriber's contact list, the subscriber should be consulted about the fee to be charged.

Of course, there are a variety of other user preferences that can be stored by the system as well. Merely by way of example, user preferences might indicate how charged fees should be dispersed to the subscriber (e.g., by deposit to a financial account specified in the user preferences, by crediting the subscriber's account with the provider, etc.). Other user preferences might indicate some times when the communication server should control communications (e.g., particular times of day, days of the week, etc.), and other times when incoming communications should be completed to the subscriber without any control by the communication server. Other preferences might specify third parties that should never be charged a fee, or from whom communications should be blocked automatically.

In particular, the client application on a subscriber device might be configured to receive user input specifying one or more of the communication preferences and/or to communicate those preferences to the communication server. The method 300, then, can further comprise storing the communication preferences (block 310), e.g., at the communication server (or a component therefore, such as a communication controller or server component), at the subscriber device, and/or the like. Merely by way of example, the communication server might store a database of subscriber information, which can include biographical information about the subscriber, information about devices assigned to the subscriber, subscriber preferences, subscriber financial institution information, and/or the like. When a user provides or updates subscriber preferences, these preferences can be stored in one or more database records associated with the subscriber. In some aspects, the client application might store database records in its own database, and communicating subscriber preferences to the communication server might comprise synchronizing the client application's database records with the communication server's database records. (Of course, for security purposes, the communication server might only synchronize a particular subscriber's database record(s)—or a portion thereof—with that particular subscriber's device.) In other cases, the client application might not store such data locally and might simply communicate the user input to the server for storage.

In a particular aspect, some embodiments can store other information as well, such as a subscriber's contacts, which can be used (as noted above) to determine fees that should be charged (if, for instance, the subscriber does not desire to charge fees to anyone in the subscriber's address book. Hence, in some embodiments, the method 300 can comprise accessing an address book on a client device (block 315) and/or generating, from the address book, a list of contacts of the subscriber (block 320). In a particular embodiment, the client application on the subscriber device can perform these functions; in another embodiment, the communication server might be configured to access the address book directly without using the client device. In either case, the communication server can receive the contact list (block 325) and can assign, in the communication preferences, one or more particular communication fees to each of the contacts (block 330), e.g., based on an amount specified by the subscriber for contacts, based on a default amount, and/or the like.

At block 335, the method 300 comprises receiving, at the communication server, a communication from a third party. As noted above, different embodiments can support a number of different modes of communication. Accordingly, the communication might be, for example, a voice call (a call from the PSTN, a VoIP call, and/or the like), an electronic mail message, a video call, a text message, a web browsing session, a social media communication, and/or the like. Virtually any such communication can be handled in similar fashion according to the method 300, although the technique for interacting with the third party might change, and the assigned communication fee might be different, depending on the mode of communication.

At block 340, the method 300 comprises determining a communication fee to be charged to the third party for completing the communication to the subscriber. In a particular aspect, the communication fee is determined based on the communication preferences, which might specify the fee at any level of granularity, as noted above. For example, the system might determine that the third party is an advertiser and determine that a particular fee specified for advertisers (perhaps specific to the mode of communication) should be charged for that communication. Alternatively, the communication preferences might specify a particular fee (or no fee) for the particular third party attempting to communicate with the subscriber, and that fee would be determined to be the applicable fee.

In a set of embodiments, as noted above, the system can allow ad hoc fee determination based on real-time subscriber input. Hence, in some embodiments, the communication preferences might specify that the subscriber should be consulted on the amount of the fee for the communication. In that situation, the method 300 can comprise identifying the third party (e.g., based on automatic identification techniques, such as caller ID, email address extraction, etc., and/or based on interaction with the third party, such as obtaining identifying information through IVR interaction, reply messages, etc.) and providing that identification of the third party to a client application (block 345). The client application can then display (or audibly play, otherwise communicate) that information to the subscriber and can receive user input from the subscriber (e.g., using a keypad, touchscreen, voice command, etc.) indicating the fee desired by the subscriber for completing the communication.

The client application can then communicate that indication of the fee to the communication server, which can receive the indication of the fee (block 350) and can use that indicated fee as the applicable fee for the instant communication. In some cases, the server might also update the subscriber's communication preferences (block 355) to use that fee as the default fee for that third party and/or that mode of communication (in which case, the subscriber might not be consulted for future communications of that third party).

At block 360, the method might comprise, in some embodiments, communicating an indication of the amount of the fee to the third party, e.g., using an appropriate user interface. Merely by way of example, if the third party's communication is an electronic mail message, the server might send a reply message with an amount of the fee required to deliver the message to the subscriber. Similarly, if the communication is a text message, the server might provide the indication by return text message. For video calls, the indication might be displayed as a graphic, while for voice calls, the indication might be played for the third party, using an IVR, for example.

At block 365, server determines whether the third party is willing to pay the applicable fee. Generally, this determination can be made based on user input from the third party; this user input often depend on the communication mode, much like the communication of the fee to the third party. For example, in an email communication, the user input might be a reply message with an indication that the third party is willing to pay the fee, while in a voice call or video call, the third party might indicate a willingness to pay the fee by speaking, pressing one or more keys on a telephone keypad, and/or the like. In some cases (for example, which one subscriber attempts to communicate with another subscriber), a client application might provide a user interface for a first subscriber to communicate with a second subscriber, and in such cases, that user interface might allow the first subscriber to pay for the communication (for example, by debiting the first subscriber's account with the communication provider or an account specified by the first subscriber's communication preferences) and/or to indicate a willingness to pay, as well.

In some embodiments, the method 300 can comprise receiving payment information from the third party (block 370). This operation, in many cases, can be combined with determining that the third party is willing to pay. For example, in some cases, the system might simply inform the third party that a fee is required to complete the communication and request payment information. In that case, the receipt of the payment information can serve as the indication of the third party's willingness to pay. Payment information can take many forms, depending on the capabilities of the system (and, in particular the financial server, in embodiments that employ such a server). For example, the payment information can include routing and account numbers, for clearance through an ACH, credit card number and other verifying information for clearance through a credit card network, information for online payment processors and/or currencies, such as PayPal™ or BitCoin™, and/or the like.

The method 300, then, can comprise performing one or more financial transactions to charge the fee to the third party (block 375). The nature of the transaction will depend, of course, on the provided financial information and the capabilities of the system, but transactions can include, without limitation, processing a debit transaction from an account of the third party at a financial institution (which can be a deposit account, a credit card account, and/or the like), charging an account of the third party with the communication provider, performing a transaction with an online payment processor, and/or the like. Correspondingly, the method 300 can comprise crediting a subscriber account with the amount of the charge (perhaps after the communication provider subtracts a service fee to as a cost of performing the transaction and/or providing the communication control services described herein). The subscriber account might be an account with an outside financial institution, in which case a clearinghouse or payment processor might be used, similar to the transaction to charge the third party. In other cases, however, the subscriber might elect to have the fee applied to the subscriber's account with the communication provider, e.g., to offset a cost of the service to the subscriber, to be used to pay for communications with other subscribers, and/or the like.

Once payment for the communication has been rendered by the third party (which can include simply the provision of appropriate financial information or indication of a willingness to pay the fee, or can include completion of the financial transaction itself), the method 300 includes completing the communication for the third party (block 390), for example, by transmitting the communication to a client application on a subscriber device, by terminating a telephone call to the subscriber device, etc. The communication can be received at the subscriber device (block 395), and the third party and the subscriber can commence interactive communication (using whatever mode of communication the third party initiated). For transactional communications, such as electronic mail messages, payment of a single fee might enable a certain number of communications or communications over a certain period of time; alternatively, the subscriber's communication preferences might dictate that the third party should be charged a fee for each incoming communication, even if part of a communication thread that included an earlier payment. Alternatively and/or additionally, in some embodiments, the communication server might track outgoing communications from the subscriber, and/or the subscriber's communication preferences might specify that a third party should not be charged a fee if the subscriber initiated the communication thread or had previously engaged in an outgoing communication with that third party.

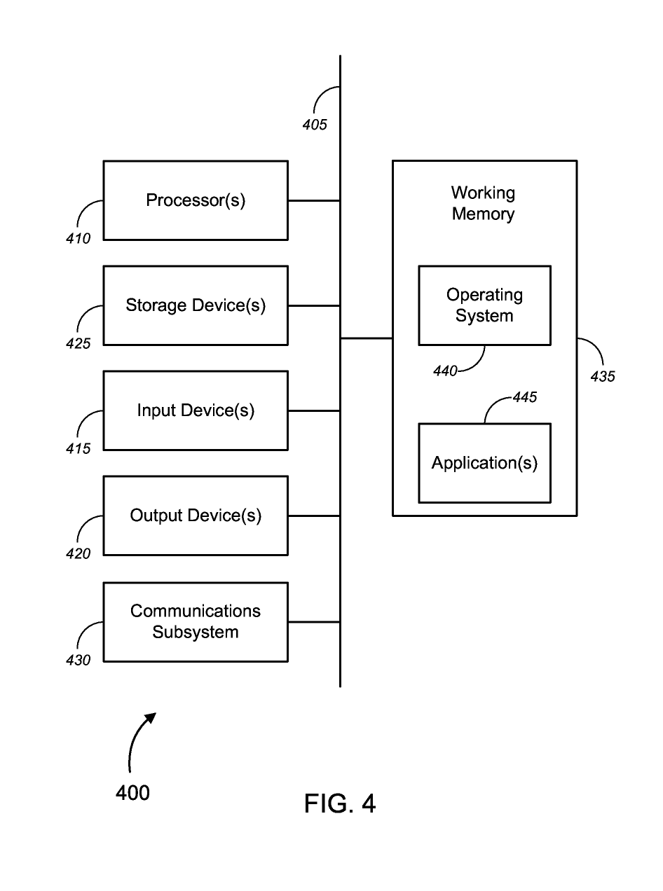

FIG. 4 provides a schematic illustration of one embodiment of a computer system 400 that can perform the methods provided by various other embodiments, as described herein, and/or can function as a communication server, server component, subscriber device, third party device, and/or the like. It should be noted that FIG. 4 is meant only to provide a generalized illustration of various components, of which one or more (or none) of each may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include one or more processors 410, including without limitation one or more general-purpose processors and/or one or more special-purpose processors (such as digital signal processing chips, graphics acceleration processors, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more storage devices 425, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 430 may permit data to be exchanged with a network (such as the network described below, to name one example), with other computer systems, and/or with any other devices described herein. In many embodiments, the computer system 400 will further comprise a working memory 435, which can include a RAM or ROM device, as described above.

The computer system 400 also may comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 400) to perform methods in accordance with various embodiments of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another computer readable medium, such as one or more of the storage device(s) 425. Merely by way of example, execution of the sequences of instructions contained in the working memory 435 might cause the processor(s) 410 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 400, various computer readable media might be involved in providing instructions/code to processor(s) 410 for execution and/or might be used to store and/or carry such instructions/code (e.g., as signals). In many implementations, a computer readable medium is a non-transitory, physical and/or tangible storage medium. Such a medium may take many forms, including but not limited to, non-volatile media, volatile media, and transmission media. Non-volatile media includes, for example, optical and/or magnetic disks, such as the storage device(s) 425. Volatile media includes, without limitation, dynamic memory, such as the working memory 435. Transmission media includes, without limitation, coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc. carried by the signals) to the working memory 435, from which the processor(s) 405 retrieves and executes the instructions. The instructions received by the working memory 435 may optionally be stored on a storage device 425 either before or after execution by the processor(s) 410.

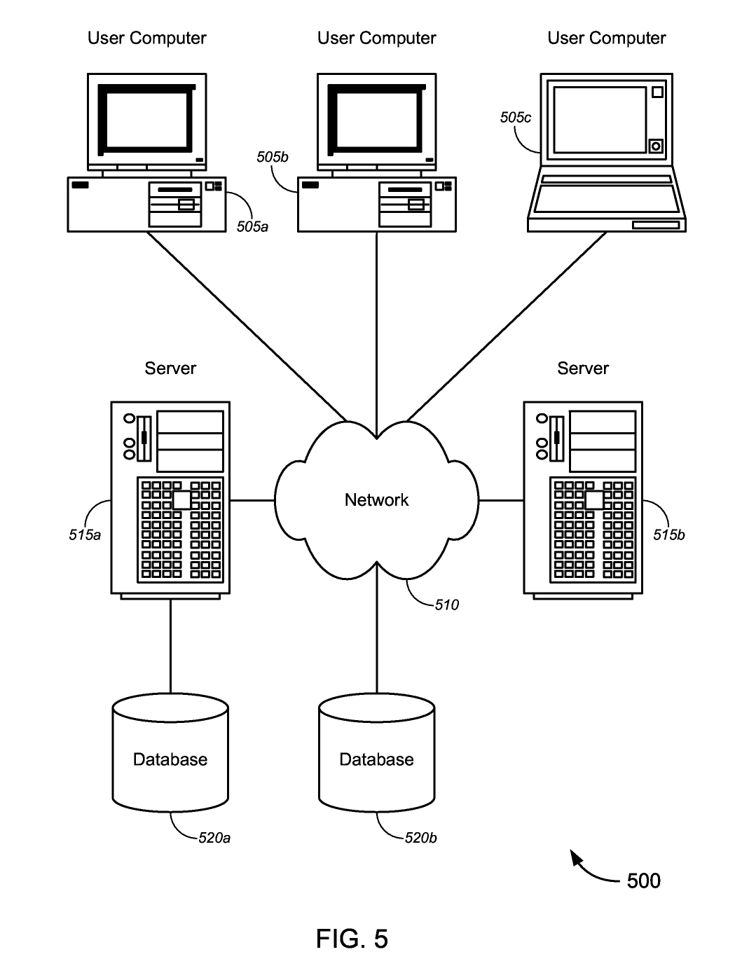

As noted above, a set of embodiments comprises systems for controlling communications to a subscriber. FIG. 5 illustrates a generalized schematic diagram of a system 500 that can be used in accordance with one set of embodiments. The system 500 can include one or more user computers 505, any of which can serve as a subscriber device and/or third party device. A user computer 505 can be a general purpose personal computer (including, merely by way of example, desktop computers, tablet computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer 505 can also have any of a variety of applications, including one or more applications configured to perform methods provided by various embodiments (as described above, for example), as well as one or more office applications, database client and/or server applications, and/or web browser applications. Alternatively, a user computer 505 can be any other electronic device, such as a thin-client computer, Internet-enabled mobile telephone, and/or personal digital assistant, capable of communicating via a network (e.g., the network 510 described below) and/or of displaying and navigating web pages or other types of electronic documents. Although the exemplary system 500 is shown with three user computers 505, any number of user computers can be supported.

Certain embodiments operate in a networked environment, which can include one or more networks (exemplified by the network 510). The network 510 can be any type of network familiar to those skilled in the art that can support voice and/or data communications using any of a variety of commercially-available (and/or free or proprietary) protocols, including without limitation TCP/IP, SNA™, IPX™, AppleTalk™, Signaling System 7 (“SS7”) voice signaling, and the like. Merely by way of example, the network 510 can include a local area network (“LAN”), including without limitation a fiber network, an Ethernet network, a Token-Ring™ network and/or the like; a wide-area network; a wireless wide area network (“WWAN”); a virtual network, such as a VPN; the Internet; an intranet; an extranet; a PSTN; an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515. Merely by way example, a server 515 might include a communication server or communication server component, as described above.

Additionally and/or alternatively, one of the servers 515 can include a web server, which can be used, merely by way of example, to process requests for web pages or other electronic documents from user computers 505. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 505 to perform methods of the invention.

The server computers 515, in some embodiments, might include one or more application servers, which can be configured with one or more applications accessible by a client running on one or more of the client computers 505 and/or other servers 515. For example, one or more servers might comprise communication servers, server components, and/or the like.

In some cases, the server(s) 515 can be one or more general purpose computers capable of executing programs or scripts in response to the user computers 505 and/or other servers 515, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle™, Microsoft™, Sybase™, IBM™ and the like, which can process requests from clients (including, depending on the configuration, dedicated database clients, API clients, web browsers, etc.) running on a user computer 505 and/or another server 515. In some embodiments, an application server can create web pages dynamically for displaying the information in accordance with various embodiments, such as web pages for providing a user interface for a subscriber to provide communication preferences or otherwise communication with a communication server, for third parties to provide payment information, and/or the like. Data provided by an application server may be formatted as one or more web pages (comprising HTML, JavaScript, etc., for example) and/or may be forwarded to a user computer 505 via a web server (as described above, for example). Similarly, a web server might receive web page requests and/or input data from a user computer 505 and/or forward the web page requests and/or input data to an application server. In some cases a web server may be integrated with an application server.

In accordance with further embodiments, one or more servers 515 can function as a file server and/or can include one or more of the files (e.g., application code, data files, etc.) necessary to implement various disclosed methods, incorporated by an application running on a user computer 505 and/or another server 515. Alternatively, as those skilled in the art will appreciate, a file server can include all necessary files, allowing such an application to be invoked remotely by a user computer 505 and/or server 515.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as it can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 520 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A system for managing communications, the system comprising:
a communication server in communication with a client application on a user device, the communication server comprising a processor and a non-transitory computer readable medium having encoded thereon a set of instructions executable by the processor to cause the communication server to perform one or more operations, the set of instructions comprising:
instructions to store communication preferences for a user of the client application, the communication preferences comprising a preference regarding communication fees applicable to one or more third parties;
instructions to receive a communication from a third party;
instructions to determine a fee for completing the communication, based on the communication preferences;
instructions to determine that the third party is willing to pay the fee;
instructions to perform a financial transaction to charge the fee to the third party; and
instructions to complete the communication to the client application, based on payment of the fee by the third party.

2. The system of claim 1, wherein the set of instructions further comprises:
instructions to communicate an indication of the fee to the third party; and
instructions to receive, from the third party, payment information for charging the fee to the third party.

3. The system of claim 1, wherein the communication preferences specify different fees for different types of communications.

4. The system of claim 1, wherein the communication preferences specify different fees for different third parties.

5. The system of claim 1, wherein the communication preferences identify one or more third parties to whom no fees are charged.

6. The system of claim 1, wherein the communication is a voice communication.

7. The system of claim 6, wherein the voice communication is a Voice over Internet Protocol (“VoIP”) call.

8. The system of claim 6, wherein the communication server comprises a Voice over Internet Protocol (“VoIP”) switch.

9. The system of claim 1, wherein the communication is an electronic mail communication.

10. The system of claim 9, wherein the communication server comprises a simple mail transfer protocol (“SMTP”) server.

11. The system of claim 1, wherein the communication is a video call.

12. The system of claim 1, wherein the communication is a text message.

13. The system of claim 12, wherein the communication server comprises a short message service center (“SMSC”).

14. The system of claim 1, wherein the communication is a web browsing session.

15. The system of claim 14, wherein the communication server comprises a web server.

16. The system of claim 1, wherein the communication is a social media communication.

17. The system of claim 1, further comprising the client application on the user device.

18. The system of claim 1, wherein the user device is a wireless phone.

19. The system of claim 1, wherein the user device is a personal computer.

20. The system of claim 1, wherein the communication server communicates with the user device over a virtual private network (“VPN”).

21. The system of claim 1, wherein the client application is integrated with an operating system of the user device.

22. The system of claim 1, wherein the client application comprises:
instructions to receive user input specifying one or more of the communication preferences; and
instructions to communicate the one or more communication preferences to the communication server.

23. The system of claim 1, wherein the set of instructions further comprises:
instructions to provide an identification of the third party to the client application after receiving the communication; and
instructions to receive from the client application, in response to the identification of the party, an indication of the fee for completing the communication.

24. The system of claim 23, wherein the set of instructions further comprises:
instructions to update the communication preferences to specify the indicated fee should be charged to the identified third party.

25. The system of claim 1, wherein the set of instructions further comprises:
instructions to receive, from the client application, a list of contacts; and
instructions to assign, in the communication preferences, a specified fee for each contact on the list of contacts.

26. The system of claim 25, wherein the client application comprises:
instructions to access an address book on the user device; and
instructions to generate the list of contacts from the address book.

27. The system of claim 1, wherein the communication preferences specify that communications from one or more third parties should be blocked.

28. The system of claim 1, wherein the communication server is operated by a communication provider, and wherein the set of instructions further comprises instructions to credit the fee to a service provider account associated with the user.

29. The system of claim 1, wherein the set of instructions further comprises instructions to credit the fee to a user account at a financial institution.

30. The system of claim 1, wherein the client application provides a user interface for the user to initiate communications through the communication server.

31. The system of claim 30, wherein the user interface enables the user to pay for communications initiated to other parties.

32. An apparatus, comprising:
a non-transitory computer readable medium having encoded thereon a set of instructions executable by one or more computers to perform one or more operations, the set of instructions comprising:
instructions to store communication preferences for a user of a client application installed on a user device, the communication preferences comprising a preference regarding communication fee applicable to one or more third parties;
instructions to receive a communication from a third party;
instructions to determine a fee for completing the communication, based on the communication preferences;
instructions to determine that the third party is willing to pay the fee;
instructions to perform a financial transaction to charge the fee to the third party; and
instructions to complete the communication to the client application, based on payment of the fee by the third party.

33. A method, comprising:
storing, on a communication server computer, communication preferences for a user of a client application on a user device, the communication preferences comprising a preference regarding communication fees applicable to one or more third parties;
receiving, by the communication server computer, a communication from a third party;
determining, by the communication server computer, a fee for completing the communication, based on the communication preferences;
determining, by the communication server computer, that the third party is willing to pay the fee;
performing, by the communication server computer, a financial transaction to charge the fee to the third party; and
completing, with the communication server computer, the communication to the client application, based on payment of the fee by the third party.

34. A user device, comprising:
a processor; and
a non-transitory computer readable medium having stored thereon a client application for a communication server, the client application comprising a set of instructions executable by the processor, the set of instructions comprising:
instructions to receive user input specifying one or more communication preferences regarding communication fees applicable to one or more third parties;
instructions to communicate the one or more communication preferences to the communication server; and
instructions to receive a communication from a third party, via the communication server, after the third party has agreed to pay a communication fee applicable to that third party.
